(19) United States
(12) Patent Application Publication
(10) Pub. No.: US 2008/0224067 A1
(43) Pub. Date: Sep. 18, 2008

(54) Laser forensic detection method and apparatus

(76) Inventors: David Clark, San Jose, CA (US); Jay T. Lofthouse-Zeis, Pleasanton, CA (US)

Correspondence Address: STALLMAN & POLLOCK LLP, 353 SACRAMENTO STREET, SUITE 2200, SAN FRANCISCO, CA, 94111, US

(21) Appl. No.: 11/788,291

(22) Filed: Apr. 19, 2007

Related U.S. Application Data
(60) Provisional application No. 60/906,642, filed on Mar. 13, 2007.

(51) Int. Cl. G21H 3/02

(52) U.S. Cl. 250/459.1

(57) ABSTRACT

A method for detecting traces of material on a surface for forensic evidence gathering is disclosed. The surface is periodically illuminated with laser radiation. Pairs of images of the surface are recorded with one image in each pair recorded while the surface is illuminated and the other being recorded while the surface is not being illuminated. The images in each pair are subtracted and a video signal is generated from the subtracted images. The video signal can be displayed on a display device or recorded for later display and examination.

### PRIORITY

This application claims priority to U.S. Provisional Application Ser. No. 60/906,642, filed Mar. 13, 2007, the disclosure of which is incorporated herein by reference.

### TECHNICAL FIELD OF THE INVENTION

The present invention relates in general to methods and apparatus for detection of trace evidence using laser stimulated fluorescence. The invention relates in particular to a method and apparatus for laser stimulated trace evidence detection in daylight conditions.

### DISCUSSION OF BACKGROUND ART

The laser is now a preferred light source for latent evidence detection, particularly of fingerprints, and also for bone fragments, skin, and traces of bodily fluids. This view is widely held throughout criminology by academics, expert witnesses, crime lab technicians, and crime scene investigators. This is because of certain properties characteristic of laser light that are not found in conventional lamps. The most important of these properties is spectral brightness.

The main purpose of a forensic light source is to excite fluorescence in tiny or trace amounts of evidence. This allows the evidence to be seen and photographed in situations where the evidence is not visible in ambient light or with conventional dusting techniques. This excitation may involve inherent fluorescence or treatment with fluorescence dyes such as ninhydrin, DFO or rhodamine 6G.

In a fluorescence detecting scheme, light is absorbed in one narrow wavelength range (color) and re-emitted in a longer wavelength range. Fluorescence is a relatively weak effect, it can be readily detected if the light source stimulating the fluorescence is sufficiently powerful and confined solely to the narrow wavelength range that is absorbed by the evidence. Blocking filters in goggles, or in front of a camera, can be used to block the wavelength of the light source allowing only light in the fluorescence band to be seen. Provided the light source itself does not generate any light in the fluorescence band, very high contrast images are possible, even for trace amounts of evidence. Thus, fluorescence requires a powerful light source with output only in a narrow wavelength band. This is usually referred to a source having as a high “spectral brightness.” The spectral brightness of a laser is many orders of magnitude greater than any lamp source.

Fluorescence evidence detection is typically carried out in dark conditions to avoid obscuration of the fluorescence by daylight or artificial light. A room can be relatively easily darkened. In outdoor locations, in daylight or under bright street lighting, however, it would be necessary to erect some kind of temporary enclosure, which could be darkened, around a location where evidence is being sought. This could be inconvenient, at best, in locations that are difficult to access, or essentially impossible when the location of suspected evidence could be anywhere in an area too great for a temporary darkening structure to be erected. Accordingly, there is a need for method and apparatus for laser stimulated trace evidence detection in daylight or brightly illuminated conditions.

### SUMMARY OF THE INVENTION

The present invention is directed to a method and apparatus for detecting traces of material on a surface. In one aspect, a method in accordance with the present invention comprises periodically illuminating the surface with light having a wavelength selected to stimulate fluorescence in the trace material. A first electronic image of the surface is recorded during a first period when the surface is illuminated by the light. A second electronic image is recorded during a second period when the surface is not being illuminated by the light. A difference image is generated from the first and second images.

The image subtraction can be repeated for sequential pairs of recorded images wherein one image in each pair is recorded when the surface is illuminated by the light and the other image in each pair is recorded when the surface is not illuminated by the light. The difference images so generated provide a video signal having a frame rate corresponding to the frequency at which the surface is illuminated (or not illuminated). The video signal can be displayed on a display device or recorded for later playback.

In one example of apparatus for carrying out the inventive method, the light is provided by an intra-cavity frequency-doubled OPS-laser optically pumped by light from a diode-laser array. The laser is switched on and off by switching the diode-laser array on and off. Image processing circuitry is incorporated in the camera for performing the image subtraction and generating the video signal. The image processing circuitry transmits a signal to the laser to trigger switching the diode-laser on and off, and appropriately synchronizing the periodic illumination with the periodic image recording.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically includes a preferred embodiment apparatus in accordance with the present invention including laser arranged to periodically illuminate a surface on which there may be latent evidence, a CCD camera arranged to periodically record electronic images of the surface, and image processing and control circuitry cooperative with the laser and the camera to synchronize the periodic illumination with the periodic recording of electronic images.

FIG. 2 is a timing diagram schematically illustrating a preferred mode of operation of the apparatus of FIG. 1 wherein the laser periodically illuminates the surface at a first frequency and the camera records the electronic images at a second frequency which is twice the first frequency, with the synchronization arranged such that one image is recorded during an illumination period and the next image is recorded between illumination periods.

### DETAILED DESCRIPTION OF THE INVENTION

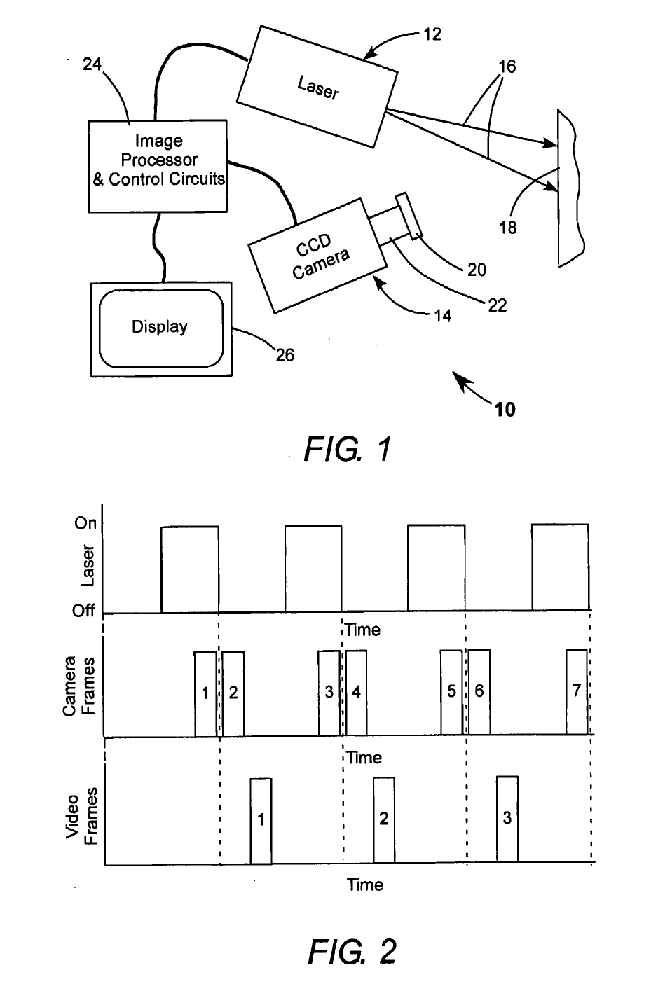

Referring now to the drawings, wherein like components are designated by like reference numerals, FIG. 1 schematically illustrates a preferred embodiment 10 of apparatus in accordance with the present invention including a laser 12 and a CCD camera 14. Laser 12 directs a light beam 16 onto a surface 18 being investigated for traces of material than might constitute latent evidence. The light has a wavelength selected to stimulate fluorescence in traces of the material being sought on the surface. The term “light” here is used generally and can be electromagnetic radiation other than visible radiation, for example, ultraviolet (UV) radiation. Wavelengths in the green or blue regions of the electromagnetic spectrum are usually preferred.

A spectral filter 20 located in front of lens 22 of camera 14 minimizes the amplitude of light in the wavelength range of the light in beam 16 entering the camera, while maximizing the transmission of light outside of this wavelength range. If a specific fluorescence wavelength range of latent evidence is expected, an additional spectral filter may be used to exclude light outside of this fluorescence-wavelength range. Alternatively, the laser-wavelength range rejecting and fluorescence-wavelength range limiting may be combined in a single spectral filter. Image processing and control circuitry 24 electronically records (“grabs”) digital images (“frames”) recorded by the CCD array (not shown) of CCD camera 14.

Continuing with reference to FIG. 1, and with reference in addition to FIG. 2, image processing and control circuitry 24 is arranged to synchronize operation of the CCD camera and the laser. The synchronization is arranged such that the camera periodically records and stores electronic images (frames) of the surface at a predetermined frequency while the laser is switched on and off (modulated) at one half of that frequency with one frame being recorded with the laser switched on and a time-adjacent frame being recorded with the laser switched off.

In a preferred arrangement depicted in FIG. 2 the laser on and laser off frames are recorded in pairs with as short as possible a time interval therebetween frames in the pair as the laser switching-off time permits. There is a longer interval between the pairs of pulses than there is between pulses in a pair.

In this arrangement clearly the term “frequency” as applied to the frame recording is applicable to the case where an extended sequence of such pairs is recorded, as will usually be the case, and should not be interpreted as limiting the recording process as having an equal interval between frames.

The image processing and control circuitry subtracts one frame from a time-adjacent fame (one frame from another in a pair thereof) to generate video frames at the same rate at which the laser is modulated. By way of example, in the scheme of FIG. 2 a series of video frames could be generated by subtracting frame 2 from frame 1, frame 4 from frame 3, frame 6 from frame 5 and so on. A series of video frames could also be generated by subtracting frame 1 from frame 2, frame 3 from frame 4, frame 5 from frame 6 and so on. In each case, the magnitude of elements of the video frames would be essentially the same although the sign may be different. The video frames so generated can be delivered directly in sequence, as a video signal, to a display device 26 as depicted in FIG. 1, or recorded on hard disc or flash memory for later playback. Recording the frames in a pair thereof as rapidly as possible limits any image distortion that might occur as a result of movement of the camera during the recording process.

It should be noted here that image processing and control circuitry 24 is depicted in FIG. 1 as a separate entity merely for convenience of description. Such circuitry could readily be included, in whole or in part, in either the camera or the laser. Indeed, it is not without the bounds of possibility to combine a laser, a camera, and necessary image processing circuitry in a common housing to provide a single portable unit. Further, while laser 12 is depicted in FIG. 1 as directly illuminating the surface, light from the laser could transported from the laser via an optical fiber or an optical fiber bundle and projected from the fiber or fiber bundle onto the surface. In either case a zoom lens could be used to project light onto the surface for selectively increasing or decreasing the illuminated area. Laser 12 can be any laser capable of delivering radiation having the desired wavelength. Diode-pumped solid-state lasers and OPS lasers are particularly preferred as such lasers can be made sufficiently efficient to be battery operated and can be readily be modulated by switching the pumping diodes on and off. Laser 12 may even be an electrically pumped diode-laser or an array thereof. These and any other modifications of the inventive apparatus may be made without departing from the spirit and scope of the present invention.

One example of the inventive apparatus was assembled to evaluate the inventive method. It was found possible to view traces of stimulated fluorescence on a surface under laboratory lighting conditions. In this example, laser 12 was an intra-cavity frequency-doubled, optically-pumped, external-cavity, surface-emitting semiconductor laser (frequency-doubled OPS laser), having an output wavelength of 530 nm, i.e., a wavelength in the green region of the electromagnetic spectrum. Light from the laser was delivered by an optical fiber to a handpiece, with the handpiece being arranged to project the light onto the surface. Such a laser, with fiber delivery and handpiece is available from Coherent, Inc., of Santa Clara, Calif. This laser was optically pumped by light from a diode-laser array in a conductively cooled package (CCP). The laser was modulated by switching the diode-laser array on and off.

Camera 14 was an ECLIPSE Ambient Light Rejection Camera available from Pixim Inc. of Mountain View, Calif. Circuitry 24 was included in the camera and programmed by the manufacturer of the camera to perform the frame subtraction for generating the video signal, and to provide a signal that was communicated to the laser to control modulation of the laser, i.e., to switch the laser on and off. Frames were recorded at a frequency of 60 hertz (Hz), i.e., in pairs thereof at 30 Hz, with the laser modulated at a frequency of 30 Hz.

The present invention is described above in terms of a preferred and other embodiments. The invention is not limited, however, to the embodiments described and depicted. Rather, the invention is limited only by the claims appended hereto.

What is claimed is:

1. A method for detecting traces of material on a surface, comprising the steps of:
periodically illuminating a surface with light having a wavelength selected to stimulate fluorescence in the trace material;
recording a first electronic image of the surface during a first period when the surface is illuminated by the light source;
recording a second electronic image during a second period when the surface is not being illuminated by the light source; and
generating a difference image from the first and second images.

2. The method of claim 1, wherein the difference image is generated by electronically subtracting the first image from the second image.

3. The method of claim 1, wherein the difference image is generated by electronically subtracting the second image from the first image.

4. The method of claim 1, wherein the fluorescence-stimulating-wavelength light is provided by a laser.

5. The method of claim 4, wherein the laser is optically pumped by light from one or more diode-lasers and the periodic illumination is accomplished by periodically switching the one or more diode-lasers on and off.

6. The method of claim 1, wherein the selected wavelength is a wavelength in the green region of the electromagnetic spectrum.

7. The method of claim 1, wherein the selected wavelength is a wavelength in the blue region of the electromagnetic spectrum.

8. A method detecting traces of material on a surface, comprising the steps of:
periodically switching a light source on and off to periodically illuminate the surface with optical radiation, the optical radiation having a wavelength selected to stimulate fluorescence in the trace material, the periodic illumination having a first frequency;
periodically activating a digital camera to sequentially record digital electronic images of the surface at a second frequency twice the first frequency;
synchronizing the surface illumination and the sequential image recording such that the sequentially recorded images are recorded as a sequence of pairs of images with one image in each pair being recorded with the light source switched on and the other image in each pair being recorded with the light source switched off; and
subtracting one image in each pair thereof from the other to generate a sequence of difference images at the first frequency to provide a digital video signal representing the surface.

9. The method of claim 8, further including the step of displaying said video signal on a video display.

10. The method of claim 8, wherein the light source is a laser.

11. The method of claim 10, wherein the laser is optically pumped by light from one or more diode-lasers and the periodic switching on and off of the laser is accomplished by periodically switching the one or more diode-lasers on and off.

12. Optical apparatus for detecting trace material on a surface, comprising:
a light source providing electromagnetic radiation having a wavelength selected to stimulate fluorescence in the trace material;
a digital video camera;
image processing and control circuitry cooperative with the camera and the laser;
said image processing and control circuitry being arranged to periodically switch said light source on and off at a predetermined frequency while recording pairs of digital images generated by said camera in sequence with one image in each pair being recorded while said light source is switched on and the other image in each pair being recorded while said light source is switched off; and
said image processing and control circuitry being further arranged to subtract one image in each pair from the other to generate a sequence of difference images for providing frames of a video signal.

13. The apparatus of claim 12, wherein said light source is a laser.

14. The apparatus of claim 13, wherein the said laser is optically pumped by one or more diode-lasers and said periodic switching on and off of the laser is accomplished by periodically switching said one or more diode-lasers on and off.

15. The apparatus of claim 14, wherein the laser is an intra-cavity, frequency-doubled OPS-laser.

16. The apparatus of claim 12, wherein said image processing and control circuitry is included in said camera and provides a signal to said laser for switching said laser on and off.
